(19) United States
(12) Patent Application Publication
(10) Pub. No.: US 2009/0166410 A1
(43) Pub. Date: Jul. 2, 2009

(54) MULTIFUNCTION ATTENDANCE CHECKING SYSTEM

(75) Inventor: Lei Song, Beijing (CN)

Correspondence Address: YING CHEN;Chen Yoshimura LLP, 255 S. GRAND AVE., # 215, LOS ANGELES, CA, 90012, US

(73) Assignee: Beijing Rutian Science and Technology Co., Ltd, Beijing (CN)

(21) Appl. No.: 12/121,039

(22) Filed: May 15, 2008

(30) Foreign Application Priority Data
Dec. 27, 2007 (CN) 200710304395.4

(51) Int. Cl. G06K 5/00

(52) U.S. Cl. 235/380

(57) ABSTRACT

This invention relates to a multifunction attendance checking system comprising a card reader for card-making, said system using the information acquired from an existed card of a user by the card reader for card-making as the user's identification information and using the existed card as a timecard of the user, further comprising a microprocessor, one or more card readers for attendance checking and a memorizer. This system allows an existed card of a user as a timecard.

### BACKGROUND OF THE INVENTION

1. Field of the Invention

This invention relates to a multifunction attendance checking system, especially to an attendance checking system with entrance guard function. This system adopts any existed electron card carried by the users as an identification card.

2. Description of the Related Art

The present attendance checking system using cards includes a microprocessor, a card reader for attendance checking, a card-making writing device, a keyboard and a memorizer as well as display unit and print unit. The card reader acquires the identification information on the timecard and automatically generates punching time record information with user information and/or user identification information as well as punching time. Meanwhile attendance state can be generated automatically according to the attendance time set in advance and be stored in the memorizer. Besides printing and/or display uniting can be processed automatically according to programs set in advance or the printing instructions inputted manually. During timecard making, user information and card writing instruction will be sent to the microprocessor via keyboard. The microprocessor will generate user identification information automatically and store it in the user information database meanwhile writing it on cars, i.e. timecard, which can be used on attendance checking machine repeatedly. The disadvantages of this technique are, firstly a special made card is needed, which increases the card quantity the users carry and causes unnecessary troubles, secondly the card-making cost is increased; thirdly in those situation with entrance guard devices, the users need punching not only for attendance but for entrance, which is more inconvenient.

### SUMMARY OF THE INVENTION

To overcome above disadvantages, this invention offers a multifunction attendance checking system of punching the clock with one card. There will be no need to make a special timecard via adopting this system. The users can employ their existed electron card to check in the attendance checking machine and the entrance will be opened automatically after the punching. There is no need to set up entrance guard systems additionally and the users will not need to punch card for attendance checking and opening the entrance respectively.

The technical solution of this invention: a multifunction attendance checking system comprising a card reader for card-making, said system using the information acquired from an existed card of a user by the card reader for card-making as the user's identification information and using the existed card as a timecard of the user.

The system further comprises a microprocessor, one or more card readers for attendance checking and a memorizer, wherein a said card reader for attendance checking reads the identification information on a timecard and send the identification information to the microprocessor, the microprocessor compares the identification information received with the identification information stored in its user information database, if the comparison is OK, generating a punching time record and an attendance statues record with the user information and storing the records in the memorizer, generating an opening instruction and sending the instruction to a entrance guard controller to open a door.

The system further comprises a keyboard used for inputting user's identification information and other information into the microprocessor and for inputting instructions of writing a card or reading a card into the microprocessor.

The microprocessor acquires an user's information from an existed card of a user by the card reader for card-making as the user's identification information according to an instruction of reading a card inputted by the keyboard, writing the user's identification information and other information into an user information database in the memorizer.

The system further comprises a card writing device, wherein the microprocessor receives a user's identification information and other information inputted by the keyboard, sends the information to the card writing device to write the information into a special timecard of the user and writes the user's identification information and other information into an user information database in the memorizer.

The system further comprises a printer and a display unit which are connected with the microprocessor.

At least one said card reader for attendance checking is installed inside door and at least one said card reader for attendance checking is installed outside door.

A said existed card of a user and a said special timecard are a magnetic card, an IC card or a non-contact IC chip.

Because the identification information recorded on the card carried by the user can be sent to the microprocessor via card reader for card-making and this information will be used as identification information on the attendance checking machine. The users can carry out attendance checking with their existed cards and there is no need to make timecards additionally, which is not only convenient to the users but reduces the cost. Meanwhile the microprocessor have confirmed the authorized users after comparing with user identification information, the users only need to punch once to perform attendance checking and entrance opening when checking in or out. This is very convenient and attendance records will be left when opening the entrance by accessing the entrance guard system, which creates condition for strict attendance management.

### BRIEF DESCRIPTION OF THE DRAWINGS

FIG. 1 is a structural scheme of this invention.

### DETAILED DESCRIPTION OF THE PREFERRED EMBODIMENTS

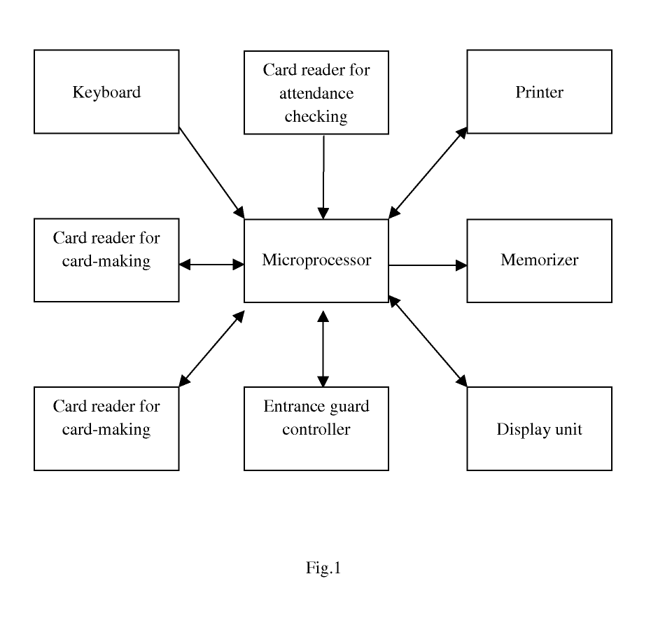

As shown in FIG. 1, this invention offers a multifunction attendance checking system of punching the clock with one card, comprising a microprocessor, a card reader for attendance checking, a card reader for card-making, a card-making writing device, a keyboard and entrance guard controllers. The card reader for attendance checking will read the identification information on timecard and send it to the microprocessor. The microprocessor will compare this identification information with the data in the user information database. As long as the comparison is successful, punching time record information will be generated automatically with user information and/or user identification information under supporting software. Meanwhile attendance state can be generated automatically according to the attendance time set in advance and be stored in the memorizer. Opening instruction will be generated automatically and sent to the entrance guard controller to open the entrance. The users' information will be inputted into the microprocessor via keyboard as well as writing card or reading card instruction. The microprocessor will acquire identification information from the electron card provided by the user as his identification information via the card reader for card-making according to the card reading instruction, and automatically write this identification information and relevant user's information into the user information database. User identification information will be generated automatically according to card writing instruction and be written into special timecard via card-making writing device. The user identification information and relevant user's information will be automatically written into the user information database.

The key technique of the invention changes the situation of making special timecard for an attendance checking system under present techniques and meanwhile the attendance checking system is combined with the entrance guard system. The information on the existed card of the user is acquired and stored in the in the database as user identification information during user information creation or modification, therefore the users are allowed to open the entrance with existed cards. This technical plan gets plenty of embodiments and can be applied on present timecard punching systems via connecting several card readers on the microprocessor (applied to different electron cards respectively, e.g. magnetic card, IC card, non-contact IC chip with induced emission function). In addition, combined with the entrance guard system, during punching timecards, the microprocessor can automatically generate opening instruction via setting appropriate programs. Therefore only some appropriate modification to the present attendance checking system can realize the technical plan of the invention.

The microprocessor can be connected to display units unit and printers. After receiving the identification information acquired by the card reader for attendance checking from the timecards, the microprocessor will automatically generate printing and/or display uniting instruction according to the set program or printing and/or display uniting instruction inputted by manual via the keyboard. This instruction will be sent to the control circuit of the printer and/or the display unit for printing and display uniting.

To guarantee the timecard punching and entrance opening of checking in and out, there are several card readers, installed inside and outside the entrance respectively.

The card readers are of different types for different user cards.

There is authority control module in the microprocessor and users without relevant authority can not access during certain time to strengthen management, especially for staff in secret service and on serial production line.

It will be apparent to those skilled in the art that various modification and variations can be made in the device of the present invention without departing from the spirit or scope of the invention. Thus, it is intended that the present invention cover modifications and variations that come within the scope of the appended claims and their equivalents.

What is claimed is:

1. A multifunction attendance checking system, comprising a card reader for card-making, said system using the information acquired from an existed card of a user by the card reader for card-making as the user's identification information and using the existed card as a timecard of the user.

2. The system of claim 1, further comprising a microprocessor, one or more card readers for attendance checking and a memorizer, wherein a said card reader for attendance checking reads the identification information on a timecard and send the identification information to the microprocessor, the microprocessor compares the identification information received with the identification information stored in its user information database, if the comparison is OK, generating a punching time record and an attendance statues record with the user information and storing the records in the memorizer, generating an opening instruction and sending the instruction to a entrance guard controller to open a door.

3. The system of claim 2, further comprising a keyboard used for inputting user's identification information and other information into the microprocessor and for inputting instructions of writing a card or reading a card into the microprocessor.

4. The system of claim 3, wherein the microprocessor acquires an user's information from an existed card of a user by the card reader for card-making as the user's identification information according to an instruction of reading a card inputted by the keyboard, writing the user's identification information and other information into an user information database in the memorizer.

5. The system of claim 4, further comprising a card writing device, wherein the microprocessor receives a user's identification information and other information inputted by the keyboard, sends the information to the card writing device to write the information into a special timecard of the user and writes the user's identification information and other information into an user information database in the memorizer.

6. The system of claim 5, further comprising a printer and a display unit which are connected with the microprocessor.

7. The system of claim 6, wherein at least one said card reader for attendance checking is installed inside door and at least one said card reader for attendance checking is installed outside door.

8. The system of claim 7, wherein a said existed card of a user and a said special timecard are a magnetic card, an IC card or a non-contact IC chip.

9. The system of claim 3, further comprising a card writing device, wherein the microprocessor receives a user's identification information and other information inputted by the keyboard, sends the information to the card writing device to write the information into a special timecard of the user and writes the user's identification information and other information into an user information database in the memorizer.

10. The system of claim 9, further comprising a printer and a display unit which are connected with the microprocessor.

11. The system of claim 10, wherein at least one said card reader for attendance checking is installed inside door and at least one said card reader for attendance checking is installed outside door.

12. The system of claim 11, wherein a said existed card of a user and a said special timecard are a magnetic card, an IC card or a non-contact IC chip.

13. The system of claim 9, wherein at least one said card reader for attendance checking is installed inside door and at least one said card reader for attendance checking is installed outside door.

14. The system of claim 2, wherein at least one said card reader for attendance checking is installed inside door and at least one said card reader for attendance checking is installed outside door.
